(19) United States
(12) Patent Application Publication
(10) Pub. No.: US 2024/0411039 A1
(43) Pub. Date: Dec. 12, 2024

(54) SYSTEM AND METHOD FOR CONDITIONING SEISMIC DATA

(71) Applicant: Schlumberger Technology Corporation, Sugar Land, TX (US)

(72) Inventor: Hiren Maniar, Houston, TX (US)

(21) Appl. No.: 18/704,527

(22) PCT Filed: Jan. 11, 2023
(86) PCT No.: PCT/US2023/060484

§ 371 Date: Apr. 25, 2024

Related U.S. Application Data
(60) Provisional application No. 63/298,383, filed on Jan. 11, 2022.

(51) Int. Cl. G01V 1/34; G01V 1/30; G01V 1/32; G01V 1/36; G06N 3/08

(52) U.S. Cl. CPC G01V 1/34; G01V 1/302; G01V 1/32; G01V 1/364; G06N 3/08; G01V 2210/514

(57) ABSTRACT

A method for conditioning seismic data includes receiving unconditioned seismic data. The method also includes introducing transformations into the unconditioned seismic data to produce transformed seismic data. The method also includes training a neural network model using the transformed seismic data to attempt to reproduce the unconditioned seismic data. The method also includes conditioning the unconditioned seismic data using the trained neural network model to produce conditioned seismic data.

### CROSS-REFERENCE TO RELATED APPLICATIONS

This application claims priority to U.S. Provisional Patent Application No. 63/298,383, filed on Jan. 11, 2022, the entirety of which is incorporated by reference herein.

### BACKGROUND

Post-stack seismic data (e.g., volumes and/or surveys) may use further conditioning or enhancements for a multitude of downstream seismic tasks (or workflows). These tasks may include seismic interpretation such as horizon detection, fault picking, noise removal, and artifact removal. These tasks can be tedious and laborious for the end-user.

### SUMMARY

Embodiments of the present disclosure may provide a method for conditioning seismic data. The method includes receiving unconditioned seismic data. The method also includes introducing transformations into the unconditioned seismic data to generate transformed seismic data. The method also includes training a neural network model using the transformed seismic data to attempt to reproduce the unconditioned seismic data. The method also includes conditioning the unconditioned seismic data using the trained neural network model to produce conditioned seismic data.

Embodiments may also include a computing system. The computing system includes one or more processors and a memory system. The memory system includes one or more computer-readable media, including but not limited to a non-transitory computer-readable medium, storing instructions that, when executed by at least one of the one or more processors, cause the computing system to perform operations. The operations include receiving unconditioned seismic data. The unconditioned seismic data includes a 3D cube representing a subterranean formation. The operations also include introducing transformations into the unconditioned seismic data to generate transformed seismic data. The transformations include a distortion and noise. Parameters of the distortion and the noise are bounded, variable, randomized, or a combination thereof. The parameters control a nature, a strength, or both of the distortion and the noise. The operations also include training a neural network model using the transformed seismic data to attempt to reproduce the unconditioned seismic data. Training the neural network model includes determining weights of the neural network model. The weights are updated using loss functions in a data domain, a frequency domain, or both. The operations also include conditioning the unconditioned seismic data using the trained neural network model to produce conditioned seismic data. Conditioning the unconditioned seismic data includes correcting the distortion and the noise, removing the distortion and noise, or both.

Embodiments may also include a computer-readable medium, including but not limited to a non-transitory computer-readable medium, storing instructions that, when executed by at least one processor of a computing system, cause the computing system to perform operation. The operations include receiving unconditioned seismic data. The unconditioned seismic data includes a 3D cube representing a subterranean formation. The operations also include introducing transformations into the unconditioned seismic data to generate transformed seismic data. The transformations include a distortion and noise. Parameters of the distortion and the noise are bounded, variable, and randomized. The parameters control a nature and a strength of the distortion and the noise. The distortion and the noise are introduced before or after reducing a dynamic range of the unconditioned seismic data, the transformed seismic data, or both. The distortion and the noise are configured to be introduced in either order or simultaneously. The operations also include training a neural network model using the transformed seismic data to attempt to reproduce the unconditioned seismic data. Training the neural network model includes determining weights of the neural network model. The weights are determined in a single or a multi-objective fashion. The weights are determined simultaneously or in a piecemeal iterative fashion. The weights are determined using single or multiple loss functions. The weights are determined with varying relative proportions of the loss functions. The weights are updated using the loss functions in a data domain, a frequency domain, or both. The operations also include conditioning the unconditioned seismic data using the trained neural network model to produce conditioned seismic data. Conditioning the unconditioned seismic data comprises correcting and removing the distortion and the noise. Conditioning the unconditioned seismic data enhances geological features. The operations also include displaying the conditioned seismic data.

This summary is provided to introduce a selection of concepts that are further described below in the detailed description. This summary is not intended to identify key or essential features of the claimed subject matter, nor is it intended to be used as an aid in limiting the scope of the claimed subject matter.

### BRIEF DESCRIPTION OF THE DRAWINGS

The accompanying drawings, which are incorporated in and constitute a part of this specification, illustrate embodiments of the present teachings and together with the description, serve to explain the principles of the present teachings. In the figures:

FIGS. 1A, 1B, 1C, 1D, 2, 3A, and 3B illustrate simplified, schematic views of an oilfield and its operation, according to an embodiment.

FIG. 4A illustrates an image of original (e.g., raw post-stack) seismic data, and FIG. 4B illustrates an image of conditioned seismic data as processed by a trained neural network, according to an embodiment.

FIG. 5A illustrates an image of original (e.g., raw post-stack) seismic data, and FIG. 5B illustrates an image of conditioned seismic data as processed by a trained neural network, according to an embodiment.

FIG. 6A illustrates an image of original (e.g., raw post-stack) seismic data, and FIG. 6B illustrates an image of conditioned seismic data as processed by a trained neural network, according to an embodiment.

FIG. 7 illustrates a flowchart of a method for conditioning seismic data, according to an embodiment.

FIG. 8 illustrates a flowchart of a method for unsupervised training of a neural network with distorted inputs and raw outputs (top), and use of a single trained machine to condition an entire volume (bottom), according to an embodiment.

FIG. 9 illustrates a flowchart of a method for conditioning seismic data, according to an embodiment.

FIG. 10 illustrates a computing system for performing at least a portion of the method(s) disclosed herein, according to an embodiment.

### DETAILED DESCRIPTION

Reference will now be made in detail to embodiments, examples of which are illustrated in the accompanying drawings and figures. In the following detailed description, numerous specific details are set forth in order to provide a thorough understanding of embodiments of the invention. However, it will be apparent to one of ordinary skill in the art that the embodiments of the invention may be practiced without these specific details. In other instances, well-known methods, procedures, components, circuits and networks have not been described in detail so as not to unnecessarily obscure aspects of the embodiments.

It will also be understood that, although the terms first, second, etc. may be used herein to describe various elements, these elements should not be limited by these terms. These terms are only used to distinguish one element from another. For example, a first object could be termed a second object, and, similarly, a second object could be termed a first object, without departing from the scope of embodiments of the invention. The first object and the second object are both objects, respectively, but they are not to be considered the same object.

The terminology used in the description herein is for the purpose of describing particular embodiments only and is not intended to be limiting of the invention. As used in the description and the appended claims, the singular forms “a,” “an” and “the” are intended to include the plural forms as well, unless the context clearly indicates otherwise. It will also be understood that the term “and/or” as used herein refers to and encompasses any possible combinations of one or more of the associated listed items. It will be further understood that the terms “includes,” “including,” “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. Further, as used herein, the term “if” may be construed to mean “when” or “upon” or “in response to determining” or “in response to detecting,” depending on the context.

Attention is now directed to processing procedures, methods, techniques and workflows that are in accordance with some embodiments. Some operations in the processing procedures, methods, techniques and workflows disclosed herein may be combined and/or the order of some operations may be changed.

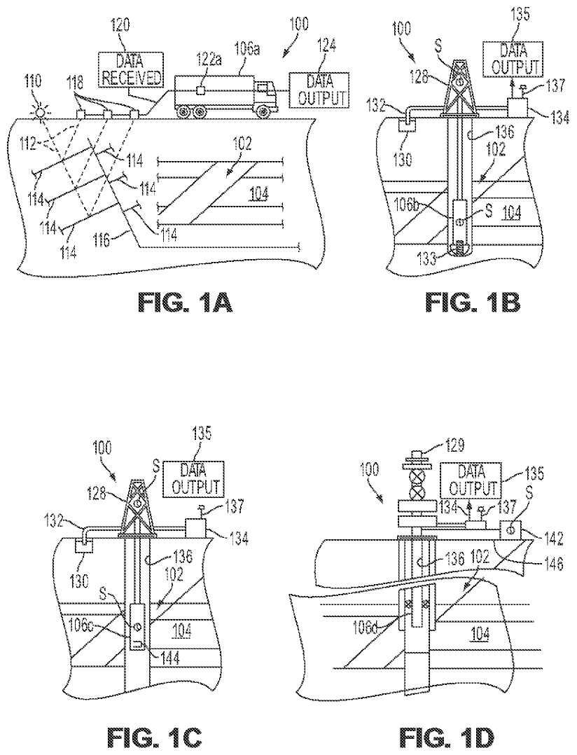

FIGS. 1A-1D illustrate simplified, schematic views of oilfield 100 having subterranean formation 102 containing reservoir 104 therein in accordance with implementations of various technologies and techniques described herein. FIG. 1A illustrates a survey operation being performed by a survey tool, such as seismic truck 106.1, to measure properties of the subterranean formation. The survey operation is a seismic survey operation for producing sound vibrations. In FIG. 1A, one such sound vibration, e.g., sound vibration 112 generated by source 110, reflects off horizons 114 in earth formation 116. A set of sound vibrations is received by sensors, such as geophone-receivers 118, situated on the earth's surface. The data received 120 is provided as input data to a computer 122.1 of a seismic truck 106.1, and responsive to the input data, computer 122.1 generates seismic data output 124. This seismic data output may be stored, transmitted or further processed as desired, for example, by data reduction.

FIG. 1B illustrates a drilling operation being performed by drilling tools 106.2 suspended by rig 128 and advanced into subterranean formations 102 to form wellbore 136. Mud pit 130 is used to draw drilling mud into the drilling tools via flow line 132 for circulating drilling mud down through the drilling tools, then up wellbore 136 and back to the surface. The drilling mud is typically filtered and returned to the mud pit. A circulating system may be used for storing, controlling, or filtering the flowing drilling mud. The drilling tools are advanced into subterranean formations 102 to reach reservoir 104. Each well may target one or more reservoirs. The drilling tools are adapted for measuring downhole properties using logging while drilling tools. The logging while drilling tools may also be adapted for taking core sample 133 as shown.

Computer facilities may be positioned at various locations about the oilfield 100 (e.g., the surface unit 134) and/or at remote locations. Surface unit 134 may be used to communicate with the drilling tools and/or offsite operations, as well as with other surface or downhole sensors. Surface unit 134 is capable of communicating with the drilling tools to send commands to the drilling tools, and to receive data therefrom. Surface unit 134 may also collect data generated during the drilling operation and produce data output 135, which may then be stored or transmitted.

Sensors (S), such as gauges, may be positioned about oilfield 100 to collect data relating to various oilfield operations as described previously. As shown, sensor (S) is positioned in one or more locations in the drilling tools and/or at rig 128 to measure drilling parameters, such as weight on bit, torque on bit, pressures, temperatures, flow rates, compositions, rotary speed, and/or other parameters of the field operation. Sensors (S) may also be positioned in one or more locations in the circulating system.

Drilling tools 106.2 may include a bottom hole assembly (BHA) (not shown), generally referenced, near the drill bit (e.g., within several drill collar lengths from the drill bit). The bottom hole assembly includes capabilities for measuring, processing, and storing information, as well as communicating with surface unit 134. The bottom hole assembly further includes drill collars for performing various other measurement functions.

The bottom hole assembly may include a communication subassembly that communicates with surface unit 134. The communication subassembly is adapted to send signals to and receive signals from the surface using a communications channel such as mud pulse telemetry, electro-magnetic telemetry, or wired drill pipe communications. The communication subassembly may include, for example, a transmitter that generates a signal, such as an acoustic or electromagnetic signal, which is representative of the measured drilling parameters. It will be appreciated by one of skill in the art that a variety of telemetry systems may be employed, such as wired drill pipe, electromagnetic or other known telemetry systems.

Typically, the wellbore is drilled according to a drilling plan that is established prior to drilling. The drilling plan typically sets forth equipment, pressures, trajectories and/or other parameters that define the drilling process for the wellsite. The drilling operation may then be performed according to the drilling plan. However, as information is gathered, the drilling operation may need to deviate from the drilling plan. Additionally, as drilling or other operations are performed, the subsurface conditions may change. The earth model may also need adjustment as new information is collected

The data gathered by sensors (S) may be collected by surface unit 134 and/or other data collection sources for analysis or other processing. The data collected by sensors (S) may be used alone or in combination with other data. The data may be collected in one or more databases and/or transmitted on or offsite. The data may be historical data, real time data, or combinations thereof. The real time data may be used in real time, or stored for later use. The data may also be combined with historical data or other inputs for further analysis. The data may be stored in separate databases, or combined into a single database.

Surface unit 134 may include transceiver 137 to allow communications between surface unit 134 and various portions of the oilfield 100 or other locations. Surface unit 134 may also be provided with or functionally connected to one or more controllers (not shown) for actuating mechanisms at oilfield 100. Surface unit 134 may then send command signals to oilfield 100 in response to data received. Surface unit 134 may receive commands via transceiver 137 or may itself execute commands to the controller. A processor may be provided to analyze the data (locally or remotely), make the decisions and/or actuate the controller. In this manner, oilfield 100 may be selectively adjusted based on the data collected. This technique may be used to optimize (or improve) portions of the field operation, such as controlling drilling, weight on bit, pump rates, or other parameters. These adjustments may be made automatically based on computer protocol, and/or manually by an operator. In some cases, well plans may be adjusted to select optimum (or improved) operating conditions, or to avoid problems.

FIG. 1C illustrates a wireline operation being performed by wireline tool 106.3 suspended by rig 128 and into wellbore 136 of FIG. 1B. Wireline tool 106.3 is adapted for deployment into wellbore 136 for generating well logs, performing downhole tests and/or collecting samples. Wireline tool 106.3 may be used to provide another method and apparatus for performing a seismic survey operation. Wireline tool 106.3 may, for example, have an explosive, radioactive, electrical, or acoustic energy source 144 that sends and/or receives electrical signals to surrounding subterranean formations 102 and fluids therein.

Wireline tool 106.3 may be operatively connected to, for example, geophones 118 and a computer 122.1 of a seismic truck 106.1 of FIG. 1A. Wireline tool 106.3 may also provide data to surface unit 134. Surface unit 134 may collect data generated during the wireline operation and may produce data output 135 that may be stored or transmitted. Wireline tool 106.3 may be positioned at various depths in the wellbore 136 to provide a survey or other information relating to the subterranean formation 102.

Sensors (S), such as gauges, may be positioned about oilfield 100 to collect data relating to various field operations as described previously. As shown, sensor S is positioned in wireline tool 106.3 to measure downhole parameters which relate to, for example porosity, permeability, fluid composition and/or other parameters of the field operation.

FIG. 1D illustrates a production operation being performed by production tool 106.4 deployed from a production unit or Christmas tree 129 and into completed wellbore 136 for drawing fluid from the downhole reservoirs into surface facilities 142. The fluid flows from reservoir 104 through perforations in the casing (not shown) and into production tool 106.4 in wellbore 136 and to surface facilities 142 via gathering network 146.

Sensors (S), such as gauges, may be positioned about oilfield 100 to collect data relating to various field operations as described previously. As shown, the sensor(S) may be positioned in production tool 106.4 or associated equipment, such as Christmas tree 129, gathering network 146, surface facility 142, and/or the production facility, to measure fluid parameters, such as fluid composition, flow rates, pressures, temperatures, and/or other parameters of the production operation.

Production may also include injection wells for added recovery. One or more gathering facilities may be operatively connected to one or more of the wellsites for selectively collecting downhole fluids from the wellsite(s).

While FIGS. 1B-1D illustrate tools used to measure properties of an oilfield, it will be appreciated that the tools may be used in connection with non-oilfield operations, such as gas fields, mines, aquifers, storage or other subterranean facilities. Also, while certain data acquisition tools are depicted, it will be appreciated that various measurement tools capable of sensing parameters, such as seismic two-way travel time, density, resistivity, production rate, etc., of the subterranean formation and/or its geological formations may be used. Various sensors (S) may be located at various positions along the wellbore and/or the monitoring tools to collect and/or monitor the desired data. Other sources of data may also be provided from offsite locations.

The field configurations of FIGS. 1A-1D are intended to provide a brief description of an example of a field usable with oilfield application frameworks. Part of, or the entirety, of oilfield 100 may be on land, water and/or sea. Also, while a single field measured at a single location is depicted, oilfield applications may be utilized with any combination of one or more oilfields, one or more processing facilities and one or more wellsites.

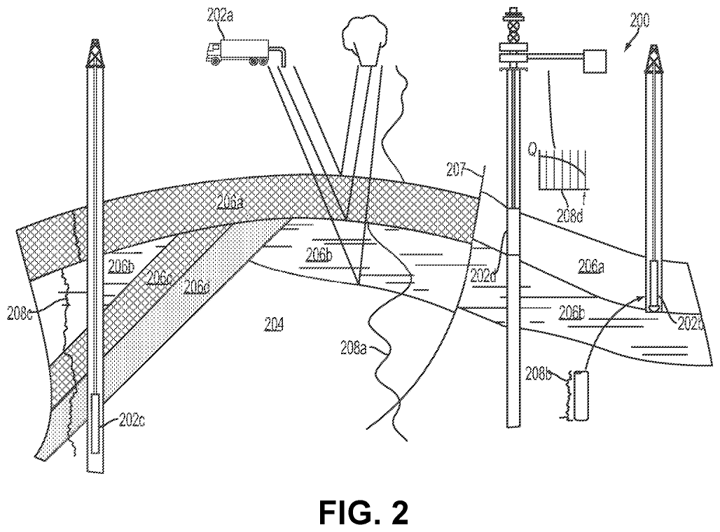

FIG. 2 illustrates a schematic view, partially in cross section of oilfield 200 having data acquisition tools 202.1, 202.2, 202.3 and 202.4 positioned at various locations along oilfield 200 for collecting data of subterranean formation 204 in accordance with implementations of various technologies and techniques described herein. Data acquisition tools 202.1-202.4 may be the same as data acquisition tools 106.1-106.4 of FIGS. 1A-1D, respectively, or others not depicted. As shown, data acquisition tools 202.1-202.4 generate data plots or measurements 208.1-208.4, respectively. These data plots are depicted along oilfield 200 to demonstrate the data generated by the various operations.

Data plots 208.1-208.3 are examples of static data plots that may be generated by data acquisition tools 202.1-202.3, respectively; however, it should be understood that data plots 208.1-208.3 may also be data plots that are updated in real time. These measurements may be analyzed to better define the properties of the formation(s) and/or determine the accuracy of the measurements and/or for checking for errors. The plots of each of the respective measurements may be aligned and scaled for comparison and verification of the properties.

Static data plot 208.1 is a seismic two-way response over a period of time. Static plot 208.2 is core sample data measured from a core sample of the formation 204. The core sample may be used to provide data, such as a graph of the density, porosity, permeability, or some other physical property of the core sample over the length of the core. Tests for density and viscosity may be performed on the fluids in the core at varying pressures and temperatures. Static data plot 208.3 is a logging trace that typically provides a resistivity or other measurement of the formation at various depths.

A production decline curve or graph 208.4 is a dynamic data plot of the fluid flow rate over time. The production decline curve typically provides the production rate as a function of time. As the fluid flows through the wellbore, measurements are taken of fluid properties, such as flow rates, pressures, composition, etc.

Other data may also be collected, such as historical data, user inputs, economic information, and/or other measurement data and other parameters of interest. As described below, the static and dynamic measurements may be analyzed and used to generate models of the subterranean formation to determine characteristics thereof. Similar measurements may also be used to measure changes in formation aspects over time.

The subterranean structure 204 has a plurality of geological formations 206.1-206.4. As shown, this structure has several formations or layers, including a shale layer 206.1, a carbonate layer 206.2, a shale layer 206.3 and a sand layer 206.4. A fault 207 extends through the shale layer 206.1 and the carbonate layer 206.2. The static data acquisition tools are adapted to take measurements and detect characteristics of the formations.

While a specific subterranean formation with specific geological structures is depicted, it will be appreciated that oilfield 200 may contain a variety of geological structures and/or formations, sometimes having extreme complexity. In some locations, typically below the water line, fluid may occupy pore spaces of the formations. Each of the measurement devices may be used to measure properties of the formations and/or its geological features. While each acquisition tool is shown as being in specific locations in oilfield 200, it will be appreciated that one or more types of measurement may be taken at one or more locations across one or more fields or other locations for comparison and/or analysis.

The data collected from various sources, such as the data acquisition tools of FIG. 2, may then be processed and/or evaluated. Typically, seismic data displayed in static data plot 208.1 from data acquisition tool 202.1 is used by a geophysicist to determine characteristics of the subterranean formations and features. The core data shown in static plot 208.2 and/or log data from well log 208.3 are typically used by a geologist to determine various characteristics of the subterranean formation. The production data from graph 208.4 is typically used by the reservoir engineer to determine fluid flow reservoir characteristics. The data analyzed by the geologist, geophysicist and the reservoir engineer may be analyzed using modeling techniques.

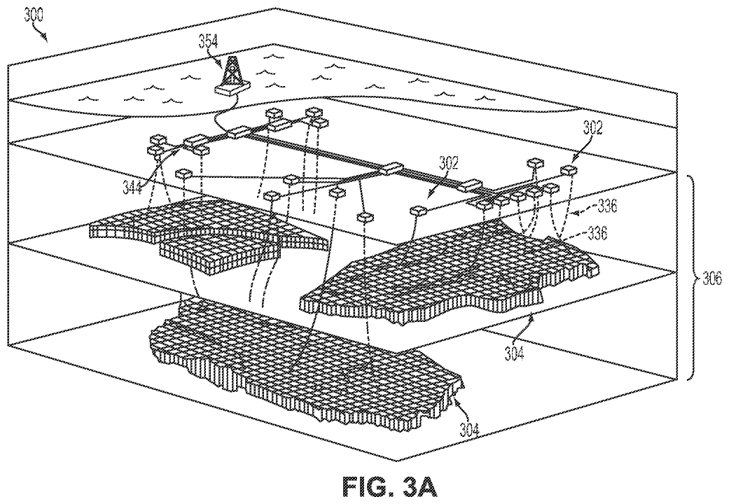

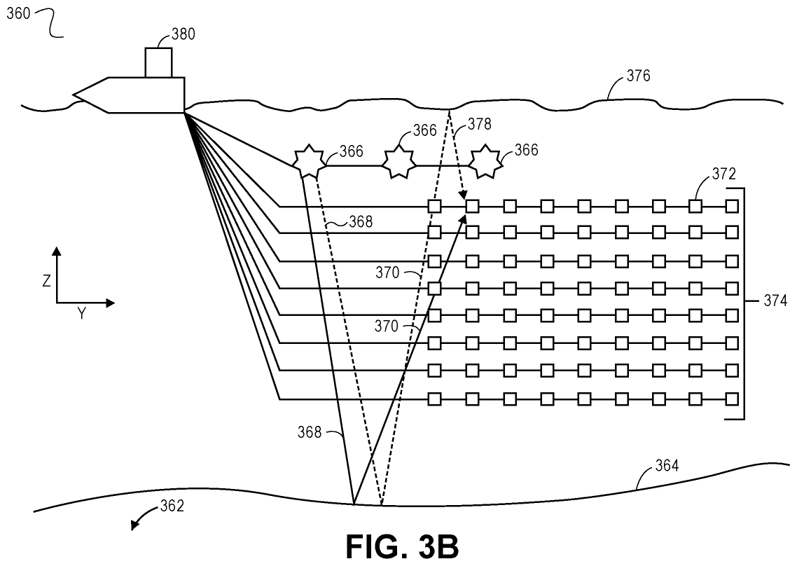

FIG. 3A illustrates an oilfield 300 for performing production operations in accordance with implementations of various technologies and techniques described herein. As shown, the oilfield has a plurality of wellsites 302 operatively connected to central processing facility 354. The oilfield configuration of FIG. 3A is not intended to limit the scope of the oilfield application system. Part, or all, of the oilfield may be on land and/or sea. Also, while a single oilfield with a single processing facility and a plurality of wellsites is depicted, any combination of one or more oilfields, one or more processing facilities and one or more wellsites may be present.

Each wellsite 302 has equipment that forms wellbore 336 into the earth. The wellbores extend through subterranean formations 306 including reservoirs 304. These reservoirs 304 contain fluids, such as hydrocarbons. The wellsites draw fluid from the reservoirs and pass them to the processing facilities via surface networks 344. The surface networks 344 have tubing and control mechanisms for controlling the flow of fluids from the wellsite to processing facility 354.

Attention is now directed to FIG. 3B, which illustrates a side view of a marine-based survey 360 of a subterranean subsurface 362 in accordance with one or more implementations of various techniques described herein. Subsurface 362 includes seafloor surface 364. Seismic sources 366 may include marine sources such as vibroseis or airguns, which may propagate seismic waves 368 (e.g., energy signals) into the Earth over an extended period of time or at a nearly instantaneous energy provided by impulsive sources. The seismic waves may be propagated by marine sources as a frequency sweep signal. For example, marine sources of the vibroseis type may initially emit a seismic wave at a low frequency (e.g., 5 Hz) and increase the seismic wave to a high frequency (e.g., 80-90 Hz) over time.

The component(s) of the seismic waves 368 may be reflected and converted by seafloor surface 364 (i.e., reflector), and seismic wave reflections 370 may be received by a plurality of seismic receivers 372. Seismic receivers 372 may be disposed on a plurality of streamers (i.e., streamer array 374). The seismic receivers 372 may generate electrical signals representative of the received seismic wave reflections 370. The electrical signals may be embedded with information regarding the subsurface 362 and captured as a record of seismic data.

In one implementation, each streamer may include streamer steering devices such as a bird, a deflector, a tail buoy and the like, which are not illustrated in this application. The streamer steering devices may be used to control the position of the streamers in accordance with the techniques described herein.

In one implementation, seismic wave reflections 370 may travel upward and reach the water/air interface at the water surface 376, a portion of reflections 370 may then reflect downward again (i.e., sea-surface ghost waves 378) and be received by the plurality of seismic receivers 372. The sea-surface ghost waves 378 may be referred to as surface multiples. The point on the water surface 376 at which the wave is reflected downward is generally referred to as the downward reflection point.

The electrical signals may be transmitted to a vessel 380 via transmission cables, wireless communication or the like. The vessel 380 may then transmit the electrical signals to a data processing center. Alternatively, the vessel 380 may include an onboard computer capable of processing the electrical signals (i.e., seismic data). Those skilled in the art having the benefit of this disclosure will appreciate that this illustration is highly idealized. For instance, surveys may be of formations deep beneath the surface. The formations may typically include multiple reflectors, some of which may include dipping events, and may generate multiple reflections (including wave conversion) for receipt by the seismic receivers 372. In one implementation, the seismic data may be processed to generate a seismic image of the subsurface 362.

Marine seismic acquisition systems tow each streamer in streamer array 374 at the same depth (e.g., 5-10 m). However, marine based survey 360 may tow each streamer in streamer array 374 at different depths such that seismic data may be acquired and processed in a manner that avoids the effects of destructive interference due to sea-surface ghost waves. For instance, marine-based survey 360 of FIG. 3B illustrates eight streamers towed by vessel 380 at eight different depths. The depth of each streamer may be controlled and maintained using the birds disposed on each streamer.

### Machine-Learning Approaches for Conditioning Seismic Data

After application of a processing algorithm, raw (e.g., unconditioned) post-stack seismic data may be considered conditioned if one or more of the following changes/attributes/tasks are observed:
noise removed or attenuated,
processing artifacts removed or attenuated,
horizon amplitudes enhanced (e.g., horizon amplitudes locally made more uniform in amplitude; small breaks in horizons filled in, etc.),
horizons made more continuous,
fault structures accentuated (e.g., fault structures made more visually evident),
signal-to-noise (SNR) ratio improved (e.g., due to removal of noise and artifacts, but maintaining the signal fidelity), and
short-scale heterogeneity attenuated or removed.
   Conditioning post-stack seismic data enables improved visual interpretation and assist in better performance of several downstream machine-learning (ML) tasks such as horizon-picking, fault detection, labelling (e.g., for supervised learning), and other seismic interpretation tasks.

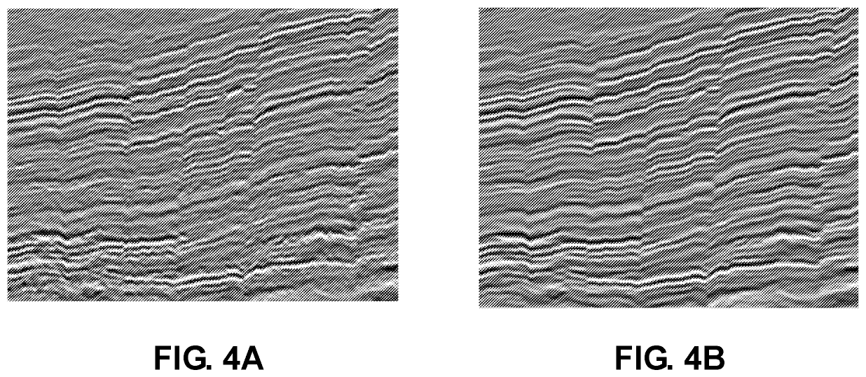

FIGS. 4A and 4B provide an example of conditioning seismic data in a subterranean formation. More particularly, FIG. 4A illustrates an image of original (e.g., raw post-stack) seismic data, and FIG. 4B illustrates an image of conditioned seismic data as processed by a trained neural network, according to an embodiment. The conditioned seismic image in FIG. 4B shows better overall visual clarity, which may allow for easier interpretation. More particularly, the conditioning has attenuated noise and short-scale heterogeneities, smoothed the horizons, enhanced some of the horizons, and accentuated the faults.

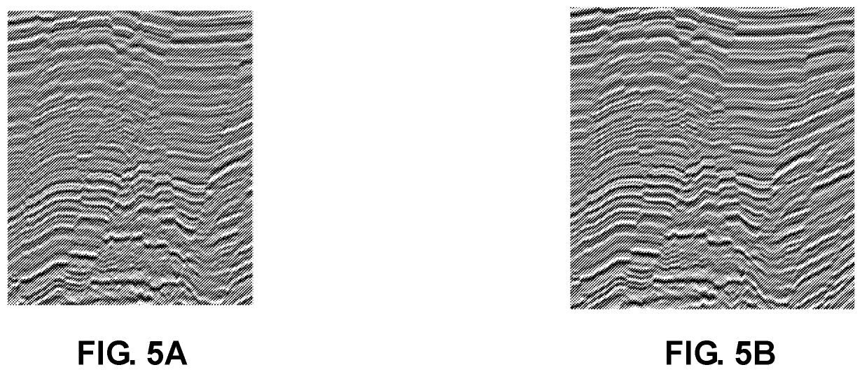

FIGS. 5A and 5B provide another example of conditioning seismic data in a subterranean formation. More particularly, FIG. 5A illustrates an image of original (e.g., raw post-stack) seismic data, and FIG. 5B illustrates an image of conditioned seismic data as processed by a trained neural network, according to an embodiment. The conditioned seismic image in FIG. 5B shows better overall visual clarity, which may allow for easier interpretation. More particularly, the conditioning has increased short-scale features, smoothed the horizons, enhanced some of the horizons, and accentuated the faults.

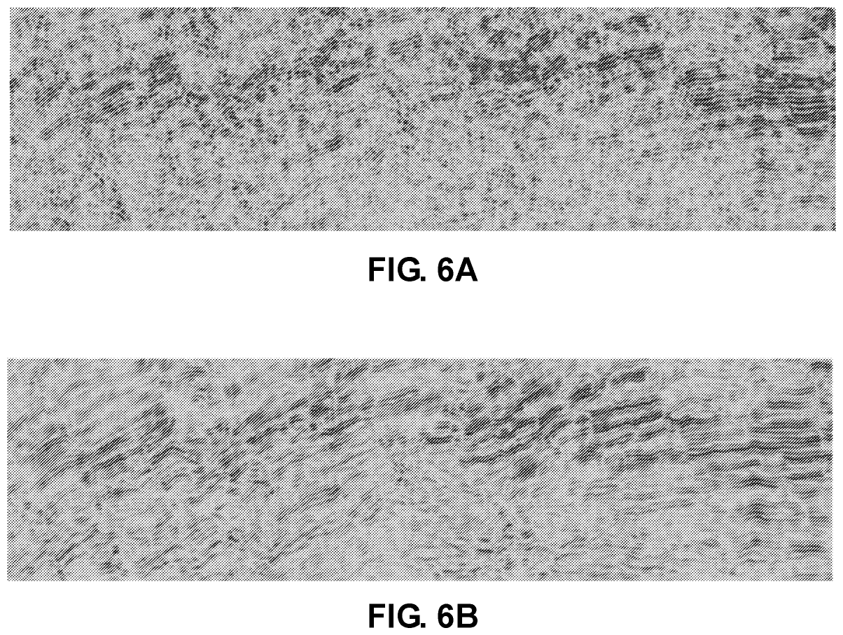

FIGS. 6A and 6B provide another example of conditioning post-stack seismic data in regions of a subterranean formation with poor horizons. More particularly, FIG. 6A illustrates an image of original (e.g., raw post-stack) seismic data, and FIG. 6B illustrates an image of conditioned seismic data as processed by a trained neural network, according to an embodiment. Simply enhancing the amplitude of the seismic data may not be sufficient. The present disclosure may also interpolate the broken horizons based at least partially upon local context to provide more continuous horizons. As may be seen, the horizons in FIG. 6A are spotty and not continuous. The horizons in FIG. 6B have better continuity.

One or more formulations are described herein, which when employed in conjunction with neural networks (NN), can condition post-stack seismic data. A neural network can learn to reconstruct the original seismic data when provided with an intentionally distorted or perturbed version of the original seismic data. Such reconstruction tasks or objectives or paradigms may result in a family of methods based on the nature of distortion employed, incorporation of noise characteristic types, and certain aspects of how the overall machine-learning leg of the problem is formulated (e.g., multi-objective or multi-tasking formulations). A neural network trained in an unsupervised fashion with one of these reconstruction tasks can condition the entire survey. One or two parameters controlling the distortion and noise characteristics may be employed by the end-user (e.g., interpreter) to target one or more of the above-mentioned conditioning tasks, and further, to steer the quality of conditioning. Various neural network architectures may be employed to accomplish the conditioning, provided that the spirit of the problem formulation is employed. The ML formulations may be utilized in seismic processing applications. The formulations may also or instead be used in cloud-based software. The formulations may also instead be used in an embarrassingly parallel mode.

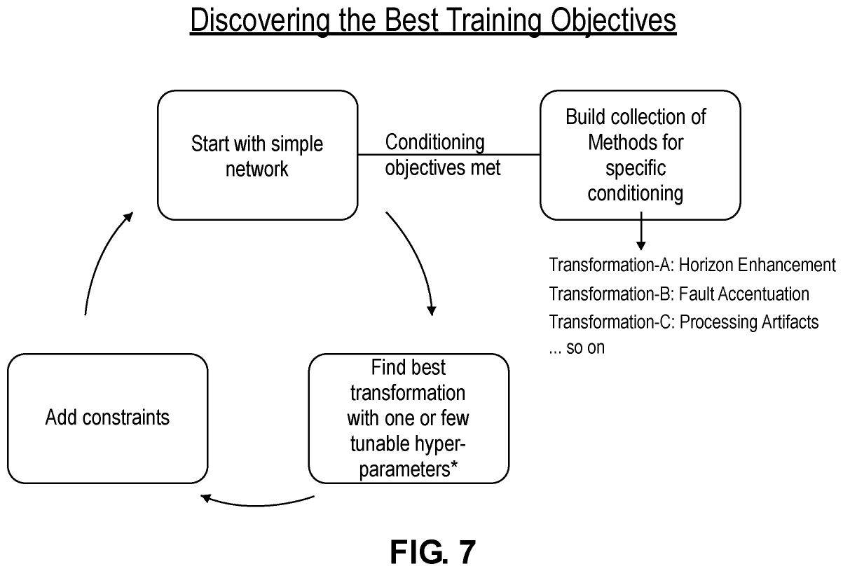

FIG. 7 illustrates a flowchart of a method for conditioning seismic data, according to an embodiment. The method may address post-stack conditioning. Post-stack seismic data (e.g., volumes and/or surveys) may use further conditioning or enhancements for a multitude of downstream seismic tasks (or workflows), including seismic interpretation such as horizon detection, fault picking, noise removal, artifact removal, or a combination thereof. As may be seen in FIG. 7, given various possibilities of the distortion (e.g., noise) models, the method may address post-stack conditioning. The training objectives may be or include reconstruction objectives.

The system and method disclosed herein may be configured to automate or semi-automate the task of seismic conditioning. In general, the approach relies on the use of distortion models (e.g., techniques) with one or more parameters, along with various noise models with one or more parameters, to generate distorted seismic data, which in turn is used to robustly train a neural network to modify or reconstruct the original (e.g., raw) data. The conditioning occurs because a neural network cannot accurately reproduce the original data, and it may learn to respect features it has encountered consistently. Thus, if distortions are repeatedly introduced in a random or unrepeating fashion (e.g., with some similarity with those present in the untreated data), the neural network may not learn such distortions. Due to such intentional conflation, eventually the network during the inference stage may remove them from the unconditioned (e.g., original untreated) data. In practice, this translates to endowing the neural network with capabilities to condition seismic data. Some examples of conditioning are: remove or attenuate artifacts and noise; subdue or enhance short-scale heterogeneity (or mid-to high-frequency components); enhance horizon amplitudes and improve its continuity, while maintaining relative amplitude strengths; accentuate faults, etc., amongst several other influences. These may be viewed as conditioning tasks, and one or more of these tasks may be accomplished (e.g., simultaneously) by employing one or more distortion models during the neural network training (i.e., multi-tasking). The choice of the distortion and noise models, along with constraints, together may provide a family of techniques, and while most may be employed for a wide range of survey types, certain choices maybe used under unique or exacting situations.

The distortion model, the noise model, or both, as well as any explicit constraints, may be controlled via one or more managed parameters, and thus the nature of conditioning can be steered. During training, these parameters may be employed in a bounded, variable, and/or randomized fashion, to ensure the distortions introduced are everchanging. This may be done to prevent the network from learning any specific distortion artifacts because the network can learn consistent and repeatable patterns. The same may hold true of how the noise models are deployed during training.

The system and method may expose one or more parameters (also called hyperparameters), which provide the user with a means to steer the nature of conditioning. In other words, the user may choose to steer conditioning based on specific survey characteristics, or to achieve certain desirable qualities for downstream tasks. Intentionally introducing a small set of parameters for conditioning control is described below.

A single trained neural network with sufficient capacity can be applied to the entire survey in a single pass, thus alleviating the need for the user to tweak or recalibrate parameters slice by slice and/or region by region. Under the above-mentioned training paradigm, the trained neural network has learned to apply the corrective actions based on local context and patterns learned. This methodology may also be employed to remove coherent noise provided that the local context within which the coherent noise occurs is widely diverse. Thus, distorting the local context may help remove certain kinds of coherent noise and/or artifacts. The narrow receptive fields of neural networks may have a bearing on such functionality.

The present disclosure may collectively be viewed as a family of methods with the general idea that a neural network can learn to reconstruct the original seismic data when provided with intentionally distorted or perturbed examples of the original seismic data. By design, the reconstruction may not be perfect, and this results in data conditioning with the above-mentioned desirable attributes. Distortion or perturbations may be used to change features within the data, or visually suppress salient aspects of the data. Incorporating noise serves to obfuscate the data further. Based on how one defines such distortions and noise, a family of methods may be conceived, each possibly with unique and desirable conditioning outcomes. Each of these distortion methods is characterized by a few parameters which control the nature and/or strength of distortion. It is these parameters which can be used to control and randomize the distortion, effectively endowing the trained neural network with conditioning capabilities, and further, bounds on these parameters also allow the expert to steer the quality of conditioning.

### Training a Neural Network to Condition Seismic Volumes

A neural network takes as input one or more 2D seismic data slices (e.g., inline, crossline, and/or time-slices), processes the input, and outputs one or more 2D conditioned seismic data slices. Such an input and output are by design. The network is provided with numerous examples to learn to process the input in a predetermined way. Effectively, how the system defines the task to be accomplished (e.g., multiple tasks are possible), the constraints employed (e.g., multiple constraints are possible), and the type of data provided, may determine the final functionality of the neural network. During training, the network may be provided as input a diverse set of distorted and/or noisy 2D slices, and the network may then output the original or raw 2D slices. During training, the network may be provided with many such examples. Using the seismic volume provided, the system may sample a 2D slice, apply the distortion/noise model (e.g., multiple models may be applied simultaneously), feed the distorted slice as input, and the raw slice is the output. The network learns to modify (e.g., correct) the distortions because it has effectively learned to remove the noisy and/or inconsistent aspects of the image. Due to the parameters of the distortion/noise model being randomized in a bounded and controlled fashion, a capacity constrained network cannot learn such artificially induced distortions. Once the network is fully trained, it may use 2D raw slices as input, and it may output the conditioned slice. Under certain uses, the method may also distort the input during the inference stage. Various types of minimizations may be employed during the model optimization. In addition, to well-known regression-type loss functions, the method may also employ them in the frequency domain. Further, the method may formulate the problem in a multi-objective fashion, employing one or more loss functions simultaneously with relative weightage. The methodology may also permit a user to control the direction of the neural network learning by reviewing intermediate performance outcome and readjusting the distortion/noise model hyperparameters bands. Finally, in machine-learning parlance, the high-level approach described here can be viewed as unsupervised learning.

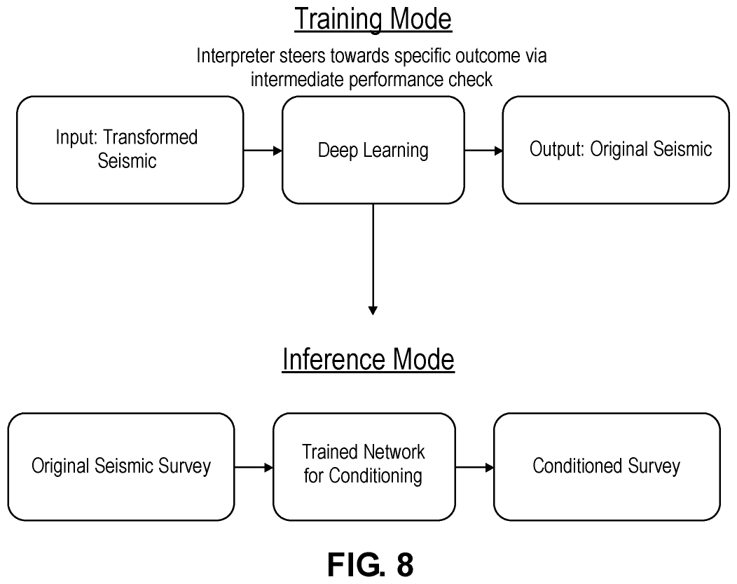

FIG. 8 illustrates a flowchart of a method for unsupervised training of a neural network with distorted inputs and raw outputs (top), and use of a single trained machine to condition an entire volume, according to an embodiment. The inference mode (bottom) may use raw seismic data as inputs and conditioned seismic data as outputs.

### Aspects of the Reconstruction Objective (i.e., Distortion)

In the example above, the input data is distorted during training. The word distortion may suggest the colloquial meaning; however, it should be noted that transformations of the data may also be appropriate. The following are a few techniques to distort data: affine transformations (e.g., rotation, shift, resizing, etc.), pixel-changes (e.g., randomly or as a correlated pattern, set certain fraction of the input to random, zero, or arbitrary values, or occlusion), quantization, frequency component change (e.g., modify certain frequency component, or a band of frequencies), defined convolution operations, filtering, or a combination thereof. Furthermore, when applicable, some of these approaches may be employed in a spatially coherent and/or pointwise manner. Coherent parts of the seismic survey itself may be used to obfuscate the 2D input at hand. These examples suggest that distortion, as used here, may include disturbing and/or perturbing data in some fashion, meaningful for the task at hand (i.e., conditioning). Further, through these examples, it should also be clear that each of these approaches is governed by one or more tunable parameters. Thus, the way in which the input data is distorted, defines the reconstruction objective. This reconstruction objective is then, by design, the task the neural network has been assigned to train on. Multiple reconstruction objectives may be employed (e.g., simultaneously) or in some controlled fashion. The method may employ one or more of the above, and the specific choices may depend on the seismic survey at hand, and/or the specifics of the artifacts seen within.

### Aspects of Noise

Along with the distortion model, a variety of noise models may also be utilized. During training, before and/or after the raw 2D slice input is distorted, noise may be added. The noise model may be used in an additive or multiplicative fashion. The approach also includes the use of these noise models incorporated as neural network layers. Noise models may be characterized by a few parameters, and as noted above, during training, the sampling from the noise model may be via a bounded, randomization of these model parameters (i.e., statistics of the noise employed may be varying). Further, and separately, parameters of the noise model may be estimated in various ways and may also be spatially dependent. The above suggests analytic models, however, the system and method may also use seismic surveys to generate and sample noise, thereby utilizing noise with non-analytic description. The method may also employ 2- or 3-dimensional distribution functions (e.g., sampling from hither dimensional distribution functions). The noise introduced may be proportional to the amplitude of the underlying data. Furthermore, distortion operators may be applied before or after the noise introduction. This noise discussion also pertains to very short-scale heterogeneities, and thus issues/choices discussed can be applicable. Finally, the distortion and noise may be utilized as a pair. In another embodiment, incorporating noise into the input data can be viewed as distortion, and thus the use of noise alone, without any distortion model, is an option.

### Reconstruction Versus Deblur

When the input is distorted, it can further be employed in two ways. If the distorted input is directly used to train the network, the task assigned to the network is reconstruction. If the distorted input is added to the raw (e.g., undistorted) data in a weighted fashion, the resulting input is a blurred version of the raw input, and the task assigned to the network can effectively be called deblurring. The method may employ one or both modes to train a network.

### Aspects of the Neural Network

The above-mentioned distortion and noise may address how the seismic data itself is used to achieve conditioning. There are several aspects of the neural network which have a bearing on accomplishing the conditioning end goal. The method may employ several neural network architectures. The method may employ aspects which bear on optimization, such as the use of (a) global loss functions, (b) auxiliary loss functions, (c) loss based on feature derivatives, (d) frequency domain constraints, or a combination thereof. The method may also employ various means for regularizing the network during training such as early stopping and/or noise. The method may also or instead train the neural network under multi-objective criteria and/or with multiple tasks.

As mentioned above, the system and method described herein may be used to condition post-stack seismic volumes for downstream tasks including allowing for easier human interpretation, and further, ML-based interpretation schemes. The system and method may also or instead be used for artifact removal, to enhance, smooth, and make continuous horizons, and/or to accentuate faults. The system and method may also be useful for seismic labelling purposes (e.g., horizons and faults may be enhanced and accentuated for downstream supervised learning tasks).

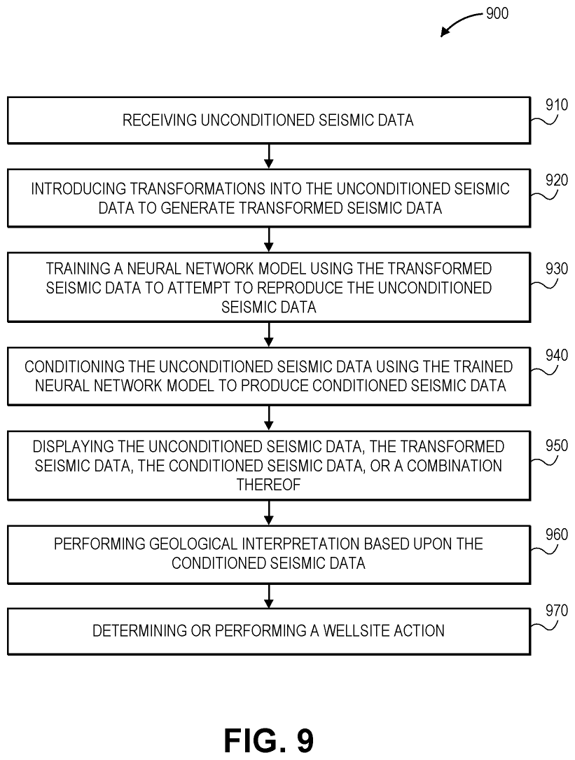

FIG. 9 illustrates a flowchart of a method 900 for conditioning seismic data, according to an embodiment. An illustrative order of the method 900 is provided below; however, one or more portions of the method 900 may be performed in a different order, combined, repeated, or omitted. At least a portion of the method 900 may be performed by the computing system (described below).

The method 900 may include receiving unconditioned seismic data, as at 910. The unconditioned seismic data may include a 3D cube representing a subterranean formation.

The method 900 may also include introducing transformations into the unconditioned seismic data to generate transformed seismic data, as at 920. The transformations may include one or more distortions, noise, or both. The distortion may be of/in a correlative fashion. One or more parameters of the distortion and/or the noise may be bounded, variable, randomized, or a combination thereof. The parameters may control a nature of the distortion and/or the noise. The parameters may also or instead control a strength of the distortion and/or the noise. The distortion and/or the noise may be introduced before and/or after reducing a dynamic range of the unconditioned seismic data and/or the transformed seismic data. The distortion and/or the noise may be configured to be introduced in either order or simultaneously. In one example, the distortion may be introduced before the noise. In another example, the distortion may be introduced after the noise.

Introducing the distortion may include performing one or more distortion tasks. The distortion tasks may include rotating the unconditioned seismic data, the transformed seismic data, or both. The distortion tasks may also or instead include shifting the unconditioned seismic data, the transformed seismic data, or both. The shifting may include relative local shifting. The distortion tasks may also or instead include resizing the unconditioned seismic data, the transformed seismic data, or both. The distortion tasks may also or instead include changing one or more pixels in the unconditioned seismic data. The one or more pixels may be changed randomly or in a correlated pattern. The distortion tasks may also or instead include setting a fraction of the unconditioned seismic data to zero, a random value, an arbitrary value, an occlusion, or a combination thereof. The distortion tasks may also or instead include quantizing the unconditioned seismic data. In one embodiment, quantizing may include dithering the unconditioned seismic data. Said another way, dithering may be applied during the quantization. The distortion tasks may also or instead include changing a frequency component of the unconditioned seismic data, the transformed seismic data, or both. The distortion tasks may also or instead include applying convolution to the unconditioned seismic data. The distortion tasks may also or instead include filtering the unconditioned seismic data, the transformed seismic data, or both. One or more of the above distortion tasks may be conducted in a single or repeated fashion. One or more of the above distortion tasks may be conducted in a predetermined or randomly chosen number of times.

Introducing the noise may include performing one or more noise tasks. In an example, the noise task may include adding a noise sample into the unconditioned seismic data, the transformed seismic data, or both. The noise sample may include a multi-dimensional probability distribution. The noise sample may be employed in an additive or multiplicative fashion.

The method 900 may also include training a neural network model using the transformed seismic data to attempt to reproduce the unconditioned seismic data, as at 930. The neural network model may be trained with the one or more distortion tasks and/or the noise task. Training the neural network model may include determining weights of the neural network model. The weights may be determined using single or multiple loss functions. The weights may be determined and/or updated using the loss functions in a data domain, a frequency domain, or both. The weights may be determined and/or updated in a single or a multi-objective fashion. The weights may be determined and/or updated simultaneously or in a piecemeal iterative fashion. The weights may be determined and/or updated with varying relative proportions of the loss functions. The training may include regularizing the neural network model. Regularizing the neural network model may include early stopping.

The method 900 may also include conditioning the unconditioned seismic data using the trained neural network model to produce conditioned seismic data, as at 940. Conditioning the unconditioned seismic data may include modifying (e.g., correcting) and/or removing the distortion and noise. Conditioning the unconditioned seismic data may include enhancing geological features (e.g., enhancing horizons in the unconditioned seismic data; accentuating faults in the unconditioned seismic data, etc.). Conditioning the unconditioned seismic data may improve additional downstream machine learning applications. The distortion and/or the noise may be implicit in the unconditioned seismic data. The distortion and/or the noise may also or instead be intentionally introduced in the transformed seismic data.

The method 900 may also include displaying the unconditioned seismic data, the transformed seismic data, the conditioned seismic data, or a combination thereof, as at 950. Examples of this are shown in FIGS. 4A-6B.

The method 900 may also include performing geological interpretation based upon the conditioned seismic data, as at 960.

The method 900 may also include determining or performing a wellsite action, as at 970. The wellsite action may be determined or performed based at least partially upon the unconditioned seismic data, the transformed seismic data, the conditioned seismic data, the geological interpretation, or a combination thereof. In one embodiment, performing the wellsite action may include generating and/or transmitting a signal (e.g., using the computing system 1000) which instructs or causes a physical action to take place. In another embodiment, performing the wellsite action may include physically performing the action (e.g., either manually or automatically). Illustrative physical actions may include, but are not limited to, selecting a location to drill a wellbore, determining risks while drilling the wellbore, drilling the wellbore, varying a trajectory of the wellbore, varying a weight on the bit of a downhole tool that is drilling the wellbore, varying a composition or flow rate of a drilling fluid that is introduced into the wellbore, or a combination thereof.

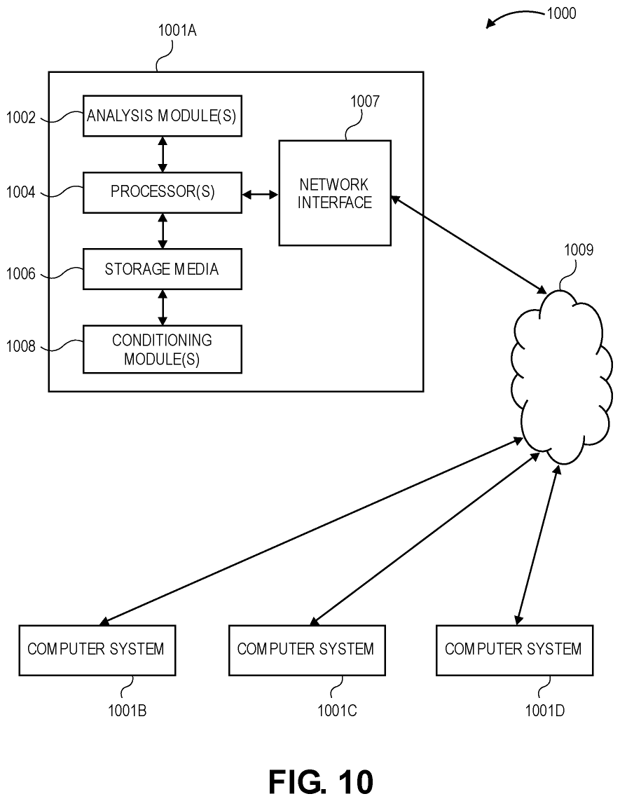

In some embodiments, any of the methods of the present disclosure may be executed by a computing system. FIG. 10 illustrates an example of such a computing system 1000, in accordance with some embodiments. The computing system 1000 may include a computer or computer system 1001A, which may be an individual computer system 1001A or an arrangement of distributed computer systems. The computer system 1001A includes one or more analysis module(s) 1002 configured to perform various tasks according to some embodiments, such as one or more methods disclosed herein. To perform these various tasks, the analysis module 1002 executes independently, or in coordination with, one or more processors 1004, which is (or are) connected to one or more storage media 1006. The processor(s) 1004 is (or are) also connected to a network interface 1007 to allow the computer system 1001A to communicate over a data network 1009 with one or more additional computer systems and/or computing systems, such as 1001B, 1001C, and/or 1001D (note that computer systems 1001B, 1001C and/or 1001D may or may not share the same architecture as computer system 1001A, and may be located in different physical locations, e.g., computer systems 1001A and 1001B may be located in a processing facility, while in communication with one or more computer systems such as 1001C and/or 1001D that are located in one or more data centers, and/or located in varying countries on different continents).

A processor can include a microprocessor, microcontroller, processor module or subsystem, programmable integrated circuit, programmable gate array, or another control or computing device.

The storage media 1006 can be implemented as one or more computer-readable or machine-readable storage media. Note that while in the example embodiment of FIG. 10 storage media 1006 is depicted as within computer system 1001A, in some embodiments, storage media 1006 may be distributed within and/or across multiple internal and/or external enclosures of computing system 1001A and/or additional computing systems. Storage media 1006 may include one or more different forms of memory including semiconductor memory devices such as dynamic or static random access memories (DRAMs or SRAMs), erasable and programmable read-only memories (EPROMs), electrically erasable and programmable read-only memories (EEPROMs) and flash memories, magnetic disks such as fixed, floppy and removable disks, other magnetic media including tape, optical media such as compact disks (CDs) or digital video disks (DVDs), BLURAY® disks, or other types of optical storage, or other types of storage devices. Note that the instructions discussed above can be provided on one computer-readable or machine-readable storage medium, or alternatively, can be provided on multiple computer-readable or machine-readable storage media distributed in a large system having possibly plural nodes. Such computer-readable or machine-readable storage medium or media is (are) considered to be part of an article (or article of manufacture). An article or article of manufacture can refer to any manufactured single component or multiple components. The storage medium or media can be located either in the machine running the machine-readable instructions, or located at a remote site from which machine-readable instructions can be downloaded over a network for execution.

In some embodiments, computing system 1000 contains one or more conditioning module(s) 1008 that may perform at least a portion of one or more of the method(s) described above. It should be appreciated that computing system 1000 is only one example of a computing system, and that computing system 1000 may have more or fewer components than shown, may combine additional components not depicted in the example embodiment of FIG. 10, and/or computing system 1000 may have a different configuration or arrangement of the components depicted in FIG. 10. The various components shown in FIG. 10 may be implemented in hardware, software, or a combination of both hardware and software, including one or more signal processing and/or application specific integrated circuits.

Further, the steps in the processing methods described herein may be implemented by running one or more functional modules in information processing apparatus such as general purpose processors or application specific chips, such as ASICs, FPGAs, PLDs, or other appropriate devices. These modules, combinations of these modules, and/or their combination with general hardware are all included within the scope of protection of embodiments of the invention.

Geologic interpretations, models and/or other interpretation aids may be refined in an iterative fashion; this concept is applicable to embodiments of the present methods discussed herein. This can include use of feedback loops executed on an algorithmic basis, such as at a computing device (e.g., computing system 1000, FIG. 10), and/or through manual control by a user who may make determinations regarding whether a given step, action, template, model, or set of curves has become sufficiently accurate for the evaluation of the subterranean three-dimensional geologic formation under consideration.

### Clauses

Clause 1: A method for conditioning seismic data includes receiving unconditioned seismic data; introducing transformations into the unconditioned seismic data to produce transformed seismic data; training a neural network model using the transformed seismic data to attempt to reproduce the unconditioned seismic data; and conditioning the unconditioned seismic data using the trained neural network model to produce conditioned seismic data.

Clause 2: The method of clause 1, wherein the unconditioned seismic data includes a 3D cube representing a subterranean formation.

Clause 3: The method of clause 1 or 2, wherein the transformations include a distortion, noise, or both.

Clause 4: The method of clause 3, wherein parameters of the distortion, the noise, or both are bounded.

Clause 5: The method of clause 3, wherein parameters of the distortion, the noise, or both are variable.

Clause 6: The method of clause 3, wherein parameters of the distortion, the noise, or both are randomized.

Clause 7: The method of clause 3, wherein parameters of the distortion, the noise, or both control a nature and a strength of the distortion, the noise, or both.

Clause 8: The method of any of clauses 1-7, wherein training the neural network model includes determining weights of the neural network model, and wherein the weights are updated using loss functions in a data domain, a frequency domain, or both.

Clause 9: The method of any of clauses 1-8, wherein conditioning the unconditioned seismic data includes: correcting the distortion, the noise, or both; removing the distortion and noise, or both; or both.

Clause 10: The method of any of clauses 1-9, further including performing a wellsite action based at least partially upon the conditioned seismic data.

Clause 11: A computing system comprising: one or more processors; and a memory system including one or more non-transitory computer-readable media storing instructions that, when executed by at least one of the one or more processors, cause the computing system to perform operations, the operations including: receiving unconditioned seismic data, wherein the unconditioned seismic data includes a 3D cube representing a subterranean formation; introducing transformations into the unconditioned seismic data to produce transformed seismic data, wherein the transformations include a distortion and noise, wherein parameters of the distortion and the noise are bounded, variable, randomized, or a combination thereof, and wherein the parameters control a nature, a strength, or both of the distortion and the noise; training a neural network model using the transformed seismic data to attempt to reproduce the unconditioned seismic data, wherein training the neural network model includes determining weights of the neural network model, and wherein the weights are updated using loss functions in a data domain, a frequency domain, or both; and conditioning the unconditioned seismic data using the trained neural network model to produce conditioned seismic data, wherein conditioning the unconditioned seismic data includes correcting the distortion and the noise, removing the distortion and noise, or both.

Clause 12: The computing system of clause 11, wherein the distortion and the noise are introduced before or after reducing a dynamic range of the unconditioned seismic data, the transformed seismic data, or both, and wherein the distortion and the noise are configured to be introduced in either order or simultaneously.

Clause 13: The computing system of clause 11 or 12, wherein the weights are determined in a single or a multi-objective fashion, and wherein the weights are determined simultaneously or in a piecemeal iterative fashion.

Clause 14: The computing system of any of clauses 11-13, wherein the weights are determined or updated with varying relative proportions of the loss functions.

Clause 15: The computing system of any of clauses 11-14, wherein the operations further include displaying the conditioned seismic data.

Clause 16: A non-transitory computer-readable medium storing instructions that, when executed by at least one processor of a computing system, cause the computing system to perform operations, the operations comprising: receiving unconditioned seismic data, wherein the unconditioned seismic data includes a 3D cube representing a subterranean formation; introducing transformations into the unconditioned seismic data to produce transformed seismic data, wherein the transformations include a distortion and noise, wherein parameters of the distortion and the noise are bounded, variable, and randomized, wherein the parameters control a nature and a strength of the distortion and the noise, wherein the distortion and the noise are introduced before or after reducing a dynamic range of the unconditioned seismic data, the transformed seismic data, or both, and wherein the distortion and the noise are configured to be introduced in either order or simultaneously; training a neural network model using the transformed seismic data to attempt to reproduce the unconditioned seismic data, wherein training the neural network model includes determining weights of the neural network model, wherein the weights are determined in a single or a multi-objective fashion, wherein the weights are determined simultaneously or in a piecemeal iterative fashion, wherein the weights are determined using single or multiple loss functions, wherein the weights are determined with varying relative proportions of the loss functions, and wherein the weights are updated using the loss functions in a data domain, a frequency domain, or both; conditioning the unconditioned seismic data using the trained neural network model to produce conditioned seismic data, wherein conditioning the unconditioned seismic data includes correcting and removing the distortion and the noise, and wherein conditioning the unconditioned seismic data enhances geological features; and displaying the conditioned seismic data.

Clause 17: The non-transitory computer-readable medium of clause 16, wherein introducing the noise includes performing a noise task, wherein the noise task includes adding a noise sample into the unconditioned seismic data, the transformed seismic data, or both, wherein the noise sample includes a multi-dimensional probability distribution, and wherein the noise sample is employed in an additive or multiplicative fashion.

Clause 18: The non-transitory computer-readable medium of clause 16 or 17, wherein the training includes regularizing the neural network model, and wherein regularizing the neural network model includes early stopping.

Clause 19: The non-transitory computer-readable medium of any of clauses 16-18, wherein the distortion and the noise are implicit in the unconditioned seismic data, and wherein the distortion and the noise are intentionally introduced in the transformed seismic data.

Clause 20: The non-transitory computer-readable medium of any of clauses 16-19, wherein the operations further include performing geological interpretation of the subterranean formation based upon the conditioned seismic data.

The foregoing description, for purpose of explanation, has been described with reference to specific embodiments. However, the illustrative discussions above are not intended to be exhaustive or to limit embodiments of the invention to the precise forms disclosed. Many modifications and variations are possible in view of the above teachings. Moreover, the order in which the elements of the methods are illustrated and described may be re-arranged, and/or two or more elements may occur simultaneously. The embodiments were chosen and described in order to best explain the principles of the invention and its practical applications, to thereby enable others skilled in the art to best utilize the invention and various embodiments with various modifications as are suited to the particular use contemplated.

What is claimed is:

1. A method for conditioning seismic data, the method comprising:
receiving unconditioned seismic data;
introducing transformations into the unconditioned seismic data to generate transformed seismic data;
training a neural network model using the transformed seismic data to attempt to reproduce the unconditioned seismic data; and
conditioning the unconditioned seismic data using the trained neural network model to produce conditioned seismic data.

2. The method of claim 1, wherein the unconditioned seismic data includes a 3D cube representing a subterranean formation.

3. The method of claim 1, wherein the transformations include a distortion, noise, or both.

4. The method of claim 3, wherein parameters of the distortion, the noise, or both are bounded.

5. The method of claim 3, wherein parameters of the distortion, the noise, or both are variable.

6. The method of claim 3, wherein parameters of the distortion, the noise, or both are randomized.

7. The method of claim 3, wherein parameters of the distortion, the noise, or both control a nature and a strength of the distortion, the noise, or both.

8. The method of claim 1, wherein training the neural network model includes determining weights of the neural network model, and wherein the weights are updated using loss functions in a data domain, a frequency domain, or both.

9. The method of claim 1, wherein conditioning the unconditioned seismic data includes:
correcting the distortion, the noise, or both;
removing the distortion and noise, or both;
or both.

10. The method of claim 1, comprising performing a wellsite action based at least partially upon the conditioned seismic data.

11. A computing system comprising:
one or more processors; and
a memory system including one or more non-transitory computer-readable media storing instructions that, when executed by at least one of the one or more processors, cause the computing system to perform operations, the operations including:
receiving unconditioned seismic data, the unconditioned seismic data includes a 3D cube representing a subterranean formation;
introducing transformations into the unconditioned seismic data to generate transformed seismic data, the transformations include a distortion and noise, parameters of the distortion and the noise are bounded, variable, randomized, or a combination thereof, and the parameters control a nature, a strength, or both of the distortion and the noise;
training a neural network model using the transformed seismic data to attempt to reproduce the unconditioned seismic data, training the neural network model includes determining weights of the neural network model, and the weights are updated using loss functions in a data domain, a frequency domain, or both; and
conditioning the unconditioned seismic data using the trained neural network model to produce conditioned seismic data, conditioning the unconditioned seismic data includes correcting the distortion and the noise, removing the distortion and noise, or both.

12. The computing system of claim 11, wherein the distortion and the noise are introduced before or after reducing a dynamic range of the unconditioned seismic data, the transformed seismic data, or both, and the distortion and the noise are configured to be introduced in either order or simultaneously.

13. The computing system of claim 11, wherein the weights are determined in a single or a multi-objective fashion, and wherein the weights are determined simultaneously or in a piecemeal iterative fashion.

14. The computing system of claim 11, wherein the weights are determined or updated with varying relative proportions of the loss functions.

15. The computing system of claim 11, wherein the operations include displaying the conditioned seismic data.

16. A non-transitory computer-readable medium storing instructions that, when executed by at least one processor of a computing system, cause the computing system to perform operations, the operations comprising:
receiving unconditioned seismic data, wherein the unconditioned seismic data includes a 3D cube representing a subterranean formation;
introducing transformations into the unconditioned seismic data to generate transformed seismic data, the transformations include a distortion and noise, parameters of the distortion and the noise are bounded, variable, and randomized, the parameters control a nature and a strength of the distortion and the noise, the distortion and the noise are introduced before or after reducing a dynamic range of the unconditioned seismic data, the transformed seismic data, or both, and the distortion and the noise are configured to be introduced in either order or simultaneously;
training a neural network model using the transformed seismic data to attempt to reproduce the unconditioned seismic data, training the neural network model includes determining weights of the neural network model, the weights are determined in a single or a multi-objective fashion, the weights are determined simultaneously or in a piecemeal iterative fashion, the weights are determined using single or multiple loss functions, the weights are determined with varying relative proportions of the loss functions, and the weights are updated using the loss functions in a data domain, a frequency domain, or both;
conditioning the unconditioned seismic data using the trained neural network model to produce conditioned seismic data, conditioning the unconditioned seismic data includes correcting and removing the distortion and the noise, and conditioning the unconditioned seismic data enhances geological features; and
displaying the conditioned seismic data.

17. The non-transitory computer-readable medium of claim 16, wherein introducing the noise includes performing a noise task, the noise task includes adding a noise sample into the unconditioned seismic data, the transformed seismic data, or both, the noise sample includes a multi-dimensional probability distribution, and the noise sample is employed in an additive or multiplicative fashion.

18. The non-transitory computer-readable medium of claim 16, wherein the training includes regularizing the neural network model, and regularizing the neural network model includes early stopping.

19. The non-transitory computer-readable medium of claim 16, wherein the distortion and the noise are implicit in the unconditioned seismic data, and the distortion and the noise are intentionally introduced in the transformed seismic data.

20. The non-transitory computer-readable medium of claim 16, wherein the operations further include performing geological interpretation of the subterranean formation based upon the conditioned seismic data.
